(19) United States
(12) Patent Application Publication
(10) Pub. No.: US 2006/0085823 A1
(43) Pub. Date: Apr. 20, 2006

(54) Media communications method and apparatus

(76) Inventors: David A. Bell, London (GB); Steffan Reymann, Redhill (GB); Liesbeth M. Scholten, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/529,665

(22) PCT Filed: Sep. 15, 2003
(86) PCT No.: PCT/IB03/04025

§ 371 Date: Mar. 29, 2005

(30) Foreign Application Priority Data
Oct. 3, 2002 (GB) 0222926.8

(51) Int. Cl. H04N 7/18; H04N 7/173

(52) U.S. Cl. 725/81; 725/80; 725/100; 725/112

(57) ABSTRACT

A method of outputting multimedia content such as a video clip on a plurality of user devices (11, 12, 13) allows users of their devices to view the video clip in substantially time synchronised manner. Devices (10,11,12) communicate with each other to exchange control signals over a telecommunications network via communications links (13,14,15). The video clip is provided to user devices in advance of viewing so that during subsequent viewing only small control instructions denoting ‘play’, ‘stop’, ‘pause’ and the like need to be communicated between devices, where such small instructions suffer less from bandwidth constraints and latency of the communications network.

The present invention relates to a method and apparatus for facilitating the output of media content on a group of user devices.

Representation of visual images, moving video, audio and other such media content (often referred to as multimedia information) in an electronic format for storage or transmission is generally recognised to require an appreciable amount of data, hence large file sizes, if that media is to be represented using an uncompressed electronic format. In order to minimise the amount of electronic data required for representation, compression techniques using various algorithms may be employed to create a representation of the media while requiring a reduced amount of electronic data. Electronic transmission of information represented in compressed format as opposed to uncompressed format requires transmission of less data so facilitating quicker transmission over a transmission channel having a particular capacity, or permitting the use of a transmission channel having a lower data carrying capacity. Furthermore, where a transmission cost is imposed on the basis of the amount of data transferred, compressed data files can result in reduced transmission costs.

Substantial reduction in the amount of data required to represent electronically audio-visual information, such as a film clip, can be obtained by encoding the audio-visual information in accordance with the MPEG-4 based standard to generate data in the MPEG-4 format (MPEG is an abbreviation for the Moving Picture Experts Group). It is noted however, that the encoding process is computationally intensive by present standards with the result that real time encoding of audio-video images into the MPEG-4 format by apparatus having the performance typically found in portable computing apparatus can take an appreciable amount of time. However, decoding of MPEG-4 data is far less computationally intensive therefore permitting the decoding and rendering of audio-visual images by portable computing apparatus for presentation on an output screen, or the like, of those devices.

As portable communication devices, such as portable telephones personal digital assistants and other personal computing apparatus, increase in their computational abilities and gain high quality display screens, users of such devices may be able to view audio-video clips on their devices. Furthermore, as such devices become equipped with cameras users may also use their devices to capture still images or even moving video clips showing their surroundings. However, in order to transfer such still images or video clips between user devices over a communications network, it will be necessary to compress the electronic representations of those images or clips before transfer takes place, for the reasons explained above.

The applicants have realised that users of communications equipment enjoy substantially real time voice communications because it allows for spontaneous and dynamic interaction between users in a way that would be possible if they were gathered together in the same place. The applicants have also realised that such users would also enjoy substantially real time viewing of the same still images or video clip in substantially synchronised manner between all users, allowing the users to discuss over a voice communications channel the images that they view simultaneously.

However, in order to achieve such simultaneous viewing of the images or video, in a scenario where a user is able to control what all users in a communications session see displayed on their devices, this requires reliable communication of the image data from one user device to another user device within a specified time limit. If the time required exceeds the time limit, the spontaneous and dynamic interaction between users is not possible due to the loss of the real time feel of the communication. Even if the amount of data representing a video clip can be compressed, hence reduced for transmission over a communications link, very quickly, the time to send the amount of data between user devices over certain communication networks can be sufficient to loose the real time feel of communications. This may even be the case where user devices communicate using a communications infrastructure based on the Global System for Mobile Communications (GSM) or Global Packet Radio Services (GPRS) system or even the Universal Mobile Telephony System (UMTS). Such networks, while having a data transfer rate that is improved over other known systems, still have a finite data carrying capacity and also suffer latency in communication of data from user to user.

It is an object of the present invention to provide a method and apparatus for controlling the output of media on two or more user devices such that output of media by those devices is performed in a substantially synchronised manner.

In accordance a first aspect of the present invention there is provided a method of controlling the output of common media content on a group of user devices, said method comprising the steps of:

generating at a one user device of the group control instructions for governing the output of multimedia content at other user devices of the group in communication with the said one user device,

transmitting said control instructions from said one device to the other user devices,

receiving at each said other user device the control instructions; and

controlling the output of media content at that other device under command of said control signals so as to facilitate output of common multimedia content at each other user device of the group in substantially synchronised manner.

Thus by communicating substantially real-time control instructions between user devices rather than communicating a representation of the media itself in real time, a smaller amount of data (comprising the control instructions) may be transferred between devices in order to achieve controlled output of the media across devices of the group, where the output is substantially synchronised across all devices of the group. Furthermore, the transfer of a smaller amount of data in particular communications infrastructures is known to be communicated with a latency lower than the latency involved with a larger amount of data. This is not just merely because there is less information to convey, but because command instructions can be implemented which are below a predetermined size and thus known to be conveyed by a communications network in one operation, for example as transfer of one service delivery unit, rather than the need to transfer a plurality of service delivery units.

Optionally, the method may further comprise the step of providing common multimedia content to said other user devices from said one user device. Otherwise, the method may further comprising the step of providing said common multimedia content from a remote source. In this case, the source may be identified by one of the user devices in the form of a Uniform Resource Locator, or other suitable pointer. The remote source may be a server or the like. The remote source may be accessed via a network for example a local area network, telecommunications network or the internet.

Optionally the method may further comprising the step of providing to at least one of the user devices at least a portion of said media content in advance of the time such multimedia content is required for output and storing that portion of multimedia content for use by said at least one user device. Therefore, either a whole file representing the media content may be provided to the user device, otherwise only a portion of the media content prior to its output, as is more common in a streaming type information delivery operation.

Optionally, the method may further comprising the steps of:

receiving at control means of said one user device control instructions generated within said device; and

controlling the output of media content at said one device under command of said control instructions so as to facilitate output of the common media content at said one device in substantially synchronised manner in comparison with output of the media content at the other user device or devices of the group. Thus, the user device that generates the control instructions may be governed in its output by the same control instructions that are transmitted to other user devices.

These and other aspects of the present invention appear in the appended claims which are incorporated herein by reference and to which the reader is now referred.

The present invention will now be described by way of example only with reference to the figures of the accompanying drawings in which:

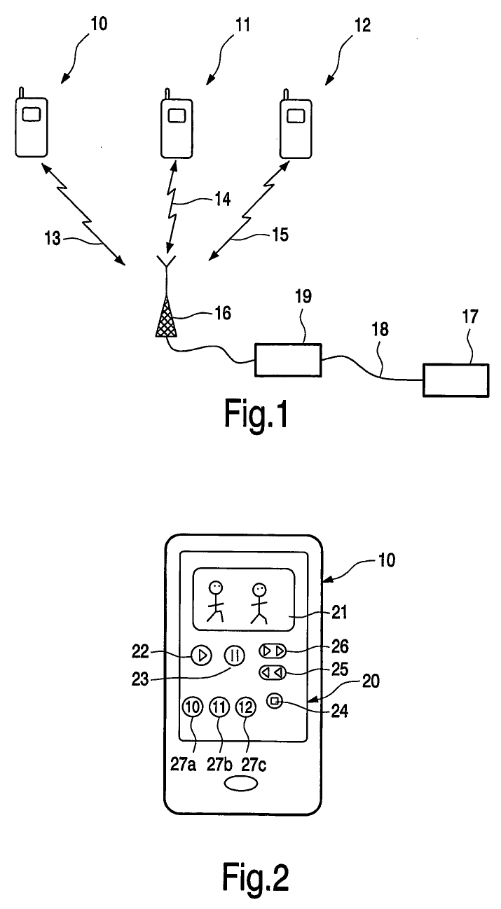

FIG. 1 is a schematic representation of user devices having communications functionality and a communications infrastructure facilitating communication between those devices;

FIG. 2 is a front view of one of the user devices; and

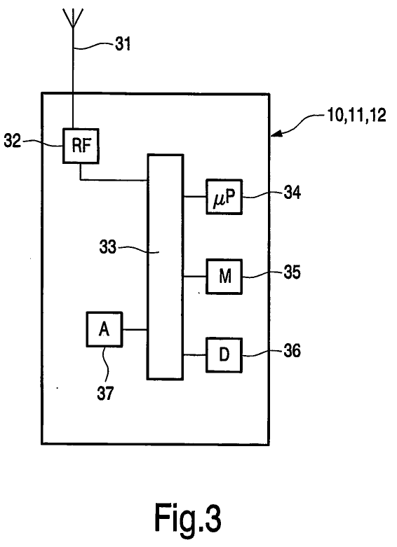

FIG. 3 is a schematic view of functional components of one of the user devices.

It should be noted that the drawings are diagrammatic and not drawn to scale. Relative dimensions and proportions of parts of the figures have been shown exaggerated or reduced in size for the sake of clarity and convenience in the drawings. The same reference signs are generally used to refer to corresponding or similar features in the different embodiments.

With reference to FIG. 1, two or more user devices, provided in the form of a group of portable user devices 10, 11, 12 communicate with each other over bidirectional communications links 13, 14, 15 respectively via a communications base station 16. In the present example, each of the user devices is a pocket computing device, such as a personal digital assistant (PDA), smartphone or other portable device with computing functionality, equipped with wireless communications apparatus suitable for facilitating the communications links 13, 14, 15. Such links may be established according to the GSM (Global System for Mobile Communication) and/or GPRS (General Packet Radio Service) system. However, for the following description of operation, other communication arrangements, such as a local area network, may be employed. Although three user devices are shown for illustration purposes, other numbers of user devices may be in communication with each other without affecting the scope of the present invention.

In a first step of operation, a user of one of the devices, in this instance user device 10, sends to each other user device 11, 12, an invitation via communication links 13, 14, 15 to join a particular session for the display of specific media content. The media content may be multimedia content such as a video clip or photographic still images. The user of each other device 14, 15 is alerted by their device to the occurrence of this invitation, together with information relating to the identity of the user device from which the invitation originates. The user of device 11, 12 may then accept or decline the invitation to join in that particular session and such acceptance or declination is relayed to device 10 via channels 13, 14, 15.

In the case that a user of the device 11, 12 accepts the invitation to join the session, this causes a copy of media content required for the session in question to be transferred to the user device 11, 12 and stored therein, ready for output to the user of the device 11, 12. In this example the media content is transmitted by user device 10 to user devices 11, 12 via communication channels 13, 14, 15.

With reference to FIG. 2, a touch display screen 20 of first user device 10 is shown. The display includes a picture output region 21 for providing a visual display of media content. The display also includes iconic representations of control buttons associated with the controls as might be found on audio visual equipment. Specifically, the representations include buttons for the commands ‘play’ denoted 22, ‘pause’ denoted 23, ‘stop’ denoted 24, ‘rewind’ denoted 25 and ‘fast forward’ denoted 26. The display also includes a representation of buttons 27a, 27b, 27c each representing a particular user device 10, 11, 12 respectively, participating in the present session, and operation of these buttons will be described in more detail below. As shown, each of these buttons 27a, 27b, 27c is labelled “10, 11, 12” corresponding to the particular user device of the session they represent, but alternately they may be labelled to show the identity of the device user in question, for example by name, telephone number or a photographic image.

In order to begin presentation of content, in this instance a video clip, a user of device 10 selects on touch screen 20 the ‘play’ button 22 which selection causes device 10 to generate a control instruction. The control instruction is received locally by control means of user device 10 and causes the device 10 to start presentation of the moving video clip for the session in question on the touch screen 20 in picture output region 21. The control means may be provided by an interaction of functional components of the user device 10, including microprocessor 34, memory 35, bus 36 and so forth, as will be described later with reference to FIG. 3. Furthermore, this control instruction is communicated from device 10 via communications link 13 and base station 16 to user devices 11 and 12 over communications links 14 and 15 respectively, which causes user devices 11, 12 and any other devices in the session to present the same moving video clip on their local display screens. Thus, the same video clip is made available to all users of devices within the same session, under control of the user of device 10. Furthermore, the video clip is made available to all users of the devices within the same session, such that the video clip is presented across all devices in a substantially synchronised manner.

The user of device 10 is also able to operate any of the further control buttons. The user of the device 10 may operate control button 23 corresponding to a ‘pause’ command which causes generation of a control instruction which pauses presentation of the video clip at device 10 but maintains a frame of the video clip in picture output region 21. The control instruction corresponding to ‘pause’ is communicated via the communications links 13, 14, 15 to devices 11, 12 resulting in those devices also pausing presentation of the video clip on their respective display screens while maintaining display of a frame of the video clip.

Further controls available to the user include ‘rewind’, initiated by actuating the button 25, and ‘fast forward’, initiated by actuating button 26. Initiation of one of these commands by a user causes generation of a control instruction which results in the video clip advancing or reversing as appropriate at increased speed, while being presented in picture output region 21. The control instruction is communicated from device 10 to user devices 11, 12 via communication lines 13, 14, 15 which result in the video clip advancing or reversing, as appropriate, at increased speed, while being output on the devices respective display screens.

A further control (not shown) includes a ‘seek’ command which allows user of device 10 to select a specific location of the video clip for output. Initiation of the seek command by a user causes device 10 to generate a control instruction which causes the device 10 to jump to the specific location and, optionally, commence playback of the video clip from that specific location. The control instruction is communicated from device 10 via communications link 13, 14, 15 to user devices 11, 12 causing those devices to also jump to the specific location of the video clip, and, optionally commence playback of the video clip from that specific location. The seek command may be used to define the specific location by frame reference or time reference in relation to the video clip; the nature of the reference used will depend on the API or CODEC.

Optionally, control instructions may be exchanged between devices 10, 11, 12 using short range wireless links as provided by Bluetooth compliant links, providing the devices are within range of each other. In this case it is not essential to send control commands via base station 16.

Optionally, the first user device 10 may generate re-synchronisation control instructions and periodically transmit those re-synchronisation control instructions over communication links 13, 14, 15 to the other user devices 11, 12. The re-synchronisation signals serve to maintain or restore synchronisation of the video clip during playback as a precaution to prevent synchronisation between devices being lost. It is possible for synchronisation to be lost in the event that there is an unaccounted delay in a control instruction generated by device 10 reaching one of the user devices 11, 12 or not reaching the user device 11, 12 at all. Synchronisation can also be lost where one of the devices 10, 11, 12 differs from the others in terms of performance which can result in a higher performance user device commencing playback of the video clip before the other user devices are able, or playback of the video clip at a speed greater than other user devices. This can also happen if a particular device has a time reference that runs at a higher speed than the others as can happen among devices that should theoretically have the same performance. This can result in ‘drift’ of synchronisation.

The user devices 10, 11, 12 are provided with audio functionality allowing reproduction of any audio that may be present in the video clip. Furthermore, the user devices 10, 11, 12 facilitate voice calls to be established among one another, allowing their users to conduct telephone calls between each other.

Thus, in use, the user of device 10 is able to control the session video clip in a way that results in substantially synchronous output of the video clip on all user devices 10, 11, 12 . . . n of the session while the user simultaneously speaks live audio commentary which is transmitted for reproduction by devices 11, 12. In fact, for a given communications session, all users involved in the session are able to hold a telephone conversation among each other in the normal manner to discuss and share thoughts about the video clip they are viewing as a group. This allows all users to share discussions and enjoy the video clip in a similar manner that they may do if they were all gathered together.

Although the above arrangement is discussed with reference to user devices 10, 11, 12 communicating via base station 16, this is by way of example only and is not to be construed as a limitation of the present invention. Such communications may be established, for example, via a number of base stations of a telecommunications network (which may be controlled by a base station controller that may itself be coupled to a mobile switching centre), or even via a number of similar or differing networks. For example, a further user device 17 in the form of a personal computer may participate in the session via a dial up link 18 which communicates via the telecommunications structure associated with base station 16 via a gateway 19.

The user buttons 27a, 27b, 27c corresponding to devices 10, 11, 12 respectively, participating in a session serve a variety of functions. They show which users are participating in a given session. Furthermore, by making one button differ from the others in appearance, that button may be used to indicate which user device is generating control instructions for a given session. Furthermore, a user may activate one of the buttons to dictate which user device of the session is permitted or enabled to generate control instructions. Such an approach can avoid confused operation and conflict during a session that can result from more than one user operating a control button 22, 23, 24, 25 or 26 at substantially the same time. Alternatively, users can verbally agree between themselves over the voice link of the session who initiates control instructions and when. As a further alternative, only the user device initiating the session is permitted to generate control instructions. Particular classes of rules governing who may control which devices and when are sometimes known as ‘floor control’ policies and a variety of suitable policies may be implemented in the present case, as will be appreciated by the person skilled in the art.

As mentioned above, the user devices may communicate over a local area network (LAN) or wireless LAN or wireless Bluetooth links. In other arrangements the user devices may communicate with each other over communication systems based on the so called Global System for Mobile Communications (GSM) or Global Packet Radio Services (GPRS) system or Universal Mobile Telephony System (UMTS)—the latter also known as “3G”. In any event, a main requirement is for the user devices to be provided with the ability to facilitate use of the devices in a manner which allows sharing and viewing of media content, for example by way of a suitable application running on the device. Such applications may be implemented in hardware, software or a combination of both.

An example of functional components of a user device 10, 11, 12 is shown schematically in FIG. 3. The components include a radio frequency (RF) antenna 31 and an RF stage 32 linking the antenna 31 to communications bus 33. The device also includes a microprocessor 34, memory 35, display 36 and audio equipment 37. Means for receiving, generating and processing control instructions are carried out through cooperation of one or more of these components.

A specific usage scenario will now be described in the context of a GSM and GPRS based communication system, although some aspects will be common in principle to communication systems based on other technologies, for example a UMTS based communication system.

During this explanation, a first mobile terminal 10 initiates a call to further mobile terminal 11 and further mobile terminal 12. Yet further mobile terminals may be involved in which case the first mobile terminal initiates calls to those further terminals also, but their participation is similar to that of the mobile terminals 11, 12 and so they do not need to be described individually.

To begin, with reference again to FIG. 1, the user of device 10 and devices 11, 12 set up an ordinary connection orientated GSM voice call via base station 16 and any associated telecommunications infrastructure; device 10 communicates with base station 16 via communications link 13 and devices 11, 12 communicate with base station 16 via communications link 14, 15 respectively. In practise a user other than that of device 10 may have initiated the call. Next a media sharing session needs to be set up. Setup of the session may be initiated by any user of a mobile terminal engaged in the voice call, but in this example it is the user of device 10. Using the communication channels 13, 14, 15 device 10 needs to send an invitation to devices 11, 12 enquiring if they would like to participate in a media sharing session.

To do this, device 10 sets up a GPRS data connection on link 13 with the base station 16, which causes among other things a dynamic IP (internet protocol) address to be assigned to the user of device 10. Next device 10 generates a SMS (short messaging system) message which contains an invite for user devices 11, 12 to join a media sharing session. Such a SMS message contains header information allowing it to be recognised by a media sharing application residing on user devices 11, 12. The SMS invite message also contains data describing the originator of the message, the dynamically assigned IP address of their device 10 and information about the media to be shared (for example in the form of a file name or subject category).

Users of devices 11, 12 are notified by the media sharing application running on their device that they are invited to participate in a media sharing session, together with information about the message originator and the nature of the video clip. Users of devices 11, 12 are able to accept or decline the invitation to participate in the media sharing session. Their reply is sent to user device 10 and this may be done by return SMS message. However, the preferred approach is for user devices 11, 12 to set up their own GPRS channel with base station 16 (irrespective of whether they accept or decline the invitation) via communications links 14, 15, respectively, which results in the user devices 11, 12 being assigned a dynamic IP address. Since devices 11, 12 know the IP address assigned to user device 10, they can send their reply to device 10 accepting or declining the invitation by a GPRS link via base station 16. The reply is directed to the media sharing application of device 10 and the user of the device 10 is notified of the responses. If a particular device 11 or 12 declined the invitation, the GPRS connection from the base station to that particular device is dropped. However, if a particular device 11 or 12 accepts the invitation, the GPRS connection is maintained; furthermore device 10 will also have been provided with the IP address assigned to devices 11 or 12, so a GPRS connection can be set up between device 10 and devices 11, 12. If at least one of the devices 11 or 12 accepts the invitation, the GPRS connection established earlier by device 10 is maintained. Thus, a GPRS connection can now be maintained between user device 10 and any of the user devices 11 or 12 which accepted the invitation to participate in the media sharing session.

The above approach to setting up GPRS connections may be necessary in those circumstances where it is not possible for a GPRS connection to be forced on a user device 11 or 12 via the network without permission of the device user. Alternatively, the user device 11, 12 may be configured by a user to engage in a GPRS connection initiated by the network or the device of another, for example user device 10, especially if the identity of that other user 10 is known and trusted. In this case the step of sending the SMS message may be dispensed with and device 10 sends invites to devices 11, 12 to participate in the media sharing session directly by GPRS connection.

Where a user accepts to participate in a media sharing session, the file of the media clip is transferred over GPRS from user device 10 to those user devices 11, 12 participating in the session. The nature of the GPRS connection may be altered to improve the rate of transfer. Once received, the user devices 11, 12 acknowledge to user device 10, via GPRS, receipt of the file.

Now the user of device 10 is able to control the appearance of video clip on all user devices of the session by operating any of the control buttons 22 to 26 to cause generation of control signals at user device 10 and hence govern the output of media information by device 10, 11 and 12 as described earlier. The control signals are transmitted by user device 10 to devices 11, 12 via communications links 13, 14, 15 using the GPRS connection.

Example control instructions and their corresponding message structures appear in the table below:

| Control Instruction | Message structure |
|---|---|
| Invitation to join media sharing | <syncplayback>, <invitation>, |
| session | <inviting user id>, <invited |
| | user id>, <session id>, <file |
| | id>, <command timestamp> |
| Acceptance of invitation to join | <syncplayback>, <accept>, |
| media sharing session | <inviting user id>, <invited |
| | user id>, <session id>, <file |
| | id>, <command timestamp> |
| Rejection of invitation to join | <syncplayback>, <reject>, |
| media sharing session | <inviting user id>, <invited |
| | user id>, <session id>, <file |
| | id>, <command timestamp> |
| End media sharing session | <syncplayback>, <end>, |
| | <inviting user id>, <invited |
| | user id>, <session id>, <file |
| | id>, <command timestamp> |
| Media navigation command, | <syncplayback>, <cmd, |
| where <cmd, argument> is one of: | argument>, <inviting user |
| <play, from location x> | id>, <invited user id>, |
| <pause, at location x> | <session id>, <flle id>, |
| <stop, at location x> | <command timestamp> |
| <fast forward, from location x> | |
| <rewind, from location x> | |
| <jump, to location x> | |
| <display, image number x> | |
| Synchronise: where | <syncplayback>, <synchronise, |
| <synchronise, threshold> contains | threshold>, <inviting user |
| a reference to frame number or | id>, <invited user id>, |
| time point of the video clip and a | <session id>, <file id>, |
| tolerance value | <command timestamp> |

The synchronisation mechanism may allow the user to specify the frequency at which synchronisation commands are generated and transmitted. Frequent generation of synchronisation commands will keep media output across all devices in relatively close synchronisation but frequent resynchronisation will result in relatively discontinuous output if there is a need to jump from one part of the sequence to another during output. Less frequent generation may result in less accurate synchronisation across devices but reduce the occurrence of jumps during output of the media resulting in smoother reproduction. However, optionally the resynchronisation command may include a tolerance value in which case the recipient user device only performs a synchronisation operation according to the command if the loss of synchronisation of that output device exceeds the threshold value. Such an arrangement will benefit from a common clock reference being made available to all user devices; such reference may be provided by the base station, network provider or a signal originating from one of the user devices that is transmitted with low latency, for example a tone burst over a voice channel.

In a GPRS system, providing control instructions are carried using a service delivery unit having a size of 128 octets or less, the mean transfer delay through a GPRS network may be less than 0.5 seconds, with 95 percent of service delivery units arriving within 1.5 seconds. Further information of the GPRS service description may be found in document reference ETSI EN 301 113 (v6.3.1 (2000-11)) of the European Telecommunications Standards Institute.

Instead of sending control instructions via the GPRS mechanism, the GSM based telecommunications system makes provision for a supplementary service by the so called User to user signalling (UUS), as described for example in document reference ETSI EN 301 702 (v7.1.2 (1999-12)) of the European Telecommunications Standards Institute.

A user device may be provided with an application for facilitating a media sharing session by providing a software stack consisting of an MPEG-4 CODEC, for example as available from Philips MP4Net, a Java Network interface on top of the CODEC, and a Java middleware layer and Java GUI (graphical user interface) on top of the middleware layer. Such application may be run on a user device such as a Compaq iPaq Pocket PC fitted with a wireless pack providing the GSM/GPRS connectivity or the symbian OS smartphone.

While the present invention has been described with reference to the above embodiments, other arrangements and variations may be envisaged without departing from the scope of the present invention. For example, the device initiating the media sharing session need not provide the media clip itself, but rather a pointer, such as a URL, to a location where the media clip is to be downloaded. Furthermore, although it is possible to download the whole media clip before output by a device, it is possible to download a portion of the media clip and commence a synchronised playback session and output of the clip; the remainder of the clip could then be delivered in the background. In this respect a system of operation closer to that of a media streaming technique may be employed to provide the media clip while still maintaining the control commands and therefore to allow the control commands to govern synchronised viewing of the media across participating devices. Yet furthermore, control instructions generated by a user device may be forwarded to a centralised ‘server’ which then forwards the control instructions to other user devices of the session, rather than sending control instructions from one user device to other user devices in a peer-to-peer type arrangement.

While the present invention is concerned with arrangements that permit a number of devices to output media in a manner that it is performed in a substantially ‘synchronised’ manner across all devices, the term synchronised is to be interpreted with a view to the system and apparatus used for implementation. For example, where control commands are communicated between user devices via a wireless LAN, the latency of the network is such that output may be synchronised to within approximately 0.1 seconds. In comparison, where control instructions are communicated via GPRS, the latency of the network means that such commands can take as long as 1.5 seconds to communicate between device, so the tolerance of synchronisation will be less optimal, but it is to be understood that in the present context the ability to control a number of devices to output the same media content in a similar manner still results in a form of synchronisation.

In yet a further arrangements, control instructions may be communicated between user devices over a conventional voice channel, for example using DTMF tones or other signalling supported by the network in question. An example includes USSD (Unstructured Supplementary Services Data) as specified in GSM standards. This approach may appear intrusive to the device users so it is advantageous to minimise perception of such tones or even seek to hide them from a user.

In some circumstances it is possible to communicate control signals between user devices 10, 11, 12 via short range wireless links, such as is possible by establishing links based on the so-called “Bluetooth” standard. In this case devices communicate with each other directly, rather than via base station 16.

In other arrangements, it may be possible for arranging for distribution of the media file to user devices before a voice call between such devices is established.

From reading the present disclosure, other modifications will be apparent to persons skilled in the art. Such modifications may involve other features which are already known in the design manufacture and use of communications apparatus, file transfer, information signalling and media coding, decoding and reproduction and applications thereof, and which may be used instead of or in addition to features already described herein.

1. A method of controlling the output of common media content on a group of user devices (10,11,12), said method comprising the steps of:
generating at a one user device (10) of the group control instructions for governing the output of multimedia content at other user devices (11,12) of the group in communication with the said one user device,
transmitting said control instructions from said one device (10) to the other user devices (11,12),
receiving at each said other user device (11,12) the control instructions; and
controlling the output of media content at that other device (11,12) under command of said control signals so as to facilitate output of common multimedia content at each other user device (11,12) of the group in substantially synchronised manner.

2. A method in accordance with claim 1 and further comprising the step of providing common multimedia content to said other user devices (11,12) from said one user device.

3. A method in accordance with claim 1 and further comprising the step of providing said common multimedia content from a remote source.

4. A method in accordance with any one or more of claims 1 to 3 and further comprising the step of providing to at least one of the user devices at least a portion of said multimedia content in advance of the time such multimedia content is required for output and storing that portion of multimedia content for use by said at least one user device.

5. A method in accordance with any one or more of claims 1 to 4 and further comprising the steps of:
receiving at control means of said one user device (10) control instructions generated within said device; and
controlling the output of media content at said one device (10) under command of said control instructions so as to facilitate output of the common media content at said one device (10) in substantially synchronised manner in comparison with output of the media content at the other user device or devices (11,12) of the group.

6. A method in accordance with any one or more of claims 1 to 5 wherein said multimedia content comprises any one member of the group comprising video sequences or a collection of photographic images.

7. A method in accordance with any one or more of claims 1 to 6 wherein said control instructions comprise representations of any member of the group of commands comprising stop, play, forward, next, rewind, previous, record, jump to sequence position x, start from sequence position x, stop at sequence position x and synchronise at sequence position x.

8. A method in accordance with any one or more of claims 1 to 7 wherein said control instructions are transmitted over a communications link (13,14,15) established by a wireless LAN, Bluetooth wireless link, GPRS and/or 3G based communication based system.

9. Apparatus having the technical features of a user device of any one or more of claims 1 to 8 and configured to perform as the user device.

10. A system configured to perform the method of any one or more of claims 1 to 8.

11. A computer program product comprising instructions for causing a programmable computer to implement the specific method steps and/or apparatus features of the invention in any of its aspects as set forth herein.

12. A computer program product as claimed in claim 11 supplied independently of any computer hardware in the form of a record carrier.

13. A computer program product as claimed in claim 11 supplied independently of any computer hardware in electronic form over a network.
